(19) United States
(12) Patent Application Publication
(10) Pub. No.: US 2016/0283438 A1
(43) Pub. Date: Sep. 29, 2016

(54) SYSTEM-ON-A-CHIP (SOC) INCLUDING HYBRID PROCESSOR CORES

(71) Applicants: Hu Tiger CHEN, Beijing (CN); Liang CHEN, Beijing (CN); Chunxiao LIN, Beijing (CN); Sai LUO, Beijing (CN); Hai Ge TIAN, Beijing (CN); Rui Gang WANG, Beijing (CN); Tin Fook NGAI, San jose, CA (US); INTEL CORPORATION, Santa Clara, CA (US)

(72) Inventors: Hu Tiger CHEN, Beijing (CN); Liang CHEN, Beijing (CN); Chunxiao LIN, Beijing (CN); Sai LUO, Beijing (CN); Hai Ge TIAN, Beijing (CN); Rui Gang WANG, Beijing (CN); Tin-Fook NGAI, San Jose, CA (US)

(21) Appl. No.: 15/038,710

(22) PCT Filed: Dec. 23, 2013
(86) PCT No.: PCT/CN2013/090225

§ 371 Date: May 23, 2016

(51) Int. Cl. G06F 15/80; G06F 13/40

(52) U.S. Cl. CPC G06F 15/80; G06F 13/4027; G06F 13/4068

(57) ABSTRACT

A processing device includes a first processor module comprising a first core designed according to a first instruction set (ISA), and a second processor module comprising a second core designed according to a second ISA. The first and second processor modules are fabricated on a same die.

### TECHNICAL FIELD

The embodiments of the disclosure relate generally to processing devices and, more specifically, relate to a system-on-a-chip that includes processors each having heterogeneous cores designed according to different instruction set architectures (ISAs).

### BACKGROUND

End users may demand a single computing device such as laptop computer, tablet computer, or smart phone to selectively operate under one of a number of ecosystems or operating systems (OSes). For example, they may desire the device to operate under a first OS (such as Android™) for personal use and under a second OS (such as Windows®) for business use.

Different types of OS may be built on processors designed according to different instruction set architectures (ISAs). For example, Intel® Architecture (IA) is a type of ISA on which Windows OS may operate, and ARM® is another type of ISA on which Android may operate. Additionally, each of the ISAs may use different sets of communication protocols as the communication interfaces among components inside the processors or between the processors and peripheral devices. Currently, device manufacturers achieve dual ecosystems on a same computing device through one of two techniques. First, the device manufacturers simply design processors of different ISAs into a single computing device. For example, the device manufacturer may implement one IA processor and one ARM processor in a computing device so that Windows applications may run on the IA processor when Windows is the forefront OS and Android applications may run on the ARM processor when Android is the forefront OS. Alternatively, device manufacturers may run a virtual machine on top of a same type of ISA processors in a computing device. The virtual machine can emulate different ecosystems from the same type of ISA instructions. For example, the computing device may execute Windows applications on a Windows virtual machine and Android applications on an Android virtual machine while the processors of the computing device can be either exclusively IA processors or exclusively ARM processors.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a processing device according to an embodiment.

FIG. 2A illustrates a processing device including a bus bridge according to an embodiment.

FIG. 2B illustrates a processing device including a system agent converter according to an embodiment.

FIG. 2C illustrates a processing device including multiple processor modules according to an embodiment.

FIG. 3A illustrates a detailed schematic of a processing device according to an embodiment.

FIG. 3B illustrates a detailed schematic of a processing device according to another embodiment.

FIG. 4 is a block diagram of a method for switching OSes in a dual-OS computing device according to an embodiment.

FIG. 5A is a block diagram illustrating a micro-architecture for a processor including heterogeneous core in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure

FIG. 11 is a block diagram of an embodiment of an SoC design in accordance with the present disclosure.

FIG. 12 illustrates a block diagram of one embodiment of a computer system.

### DETAILED DESCRIPTION

Schemes for running dual ecosystems on a same device suffer high costs, performance degradations, and high power consumptions because of redundant processors designed according to different ISAs. Another issue with the current schemes is the compatibility of binary codes running in different ISA microsystems. For example, applications compiled for ARM platforms cannot directly run on IA platforms without porting efforts. Binary translation has been used to resolve the compatibility issues among different types of ISAs. However, this solution needs runtime software which dynamically or statically translates the native library written for a non-native ISA to a native ISA. Unfortunately, binary translation introduces performance loss and does not handle all scenarios.

End users of computing devices running multiple ecosystems desire quick switches among different types of OS available on the computing device with minimum performance degradation, power consumption, and system footprint.

To efficiently achieve multi-ecosystems on a single computing device, embodiments of the disclosure provide for a System-On-A-Chip (SoC) that may include at least one central processing unit (CPU) that each includes heterogeneous ISA cores. The heterogeneous cores may include at least one core designed according to a first ISA type, and at least one core designed according to a second ISA type, where the first and second ISA types are different. For example, a first core of a CPU may be designed as a complex instruction set computing (CISC) core, and a second core for the same CPU may be designed as a reduced instruction set computing (RISC) core. More specifically, the first ISA type may be IA, and the second ISA type may be ARM. It should be noted that although the present application often refers to IA and ARM as the two exemplary ISAs for convenience, the present application is not limited to these two specific examples. The principles of the present application are equally applicable to other types of ISAs such as PowerPC® architecture.

Embodiments of the disclosure may integrate the heterogeneous cores on a same die to form an SoC so that an efficient and high-performing multi- or dual OSes may be built on a single computing device.

Embodiments of the present disclosure provide distinguishing architectures that have the advantage of lower costs and power consumption, small footprints, and high performance over current technologies.

Although the following embodiments may be described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Although the following embodiments are described with reference to a processor, other embodiments are applicable to other types of integrated circuits and logic devices. Similar techniques and teachings of embodiments of the disclosure can be applied to other types of circuits or semiconductor devices that can benefit from higher pipeline throughput and improved performance. The teachings of embodiments of the disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which includes processor logic and circuits used to implement one or more instruction sets. Accordingly, processors with different micro-architectures can share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT), a Reorder Buffer (ROB) and a retirement register file. In one embodiment, registers may include one or more registers, register architectures, register files, or other register sets that may or may not be addressable by a software programmer.

In one embodiment, an instruction may include one or more instruction formats. In one embodiment, an instruction format may indicate various fields (number of bits, location of bits, etc.) to specify, among other things, the operation to be performed and the operand(s) on which that operation is to be performed. Some instruction formats may be further broken defined by instruction templates (or sub formats). For example, the instruction templates of a given instruction format may be defined to have different subsets of the instruction format's fields and/or defined to have a given field interpreted differently. In one embodiment, an instruction is expressed using an instruction format (and, if defined, in a given one of the instruction templates of that instruction format) and specifies or indicates the operation and the operands upon which the operation will operate.

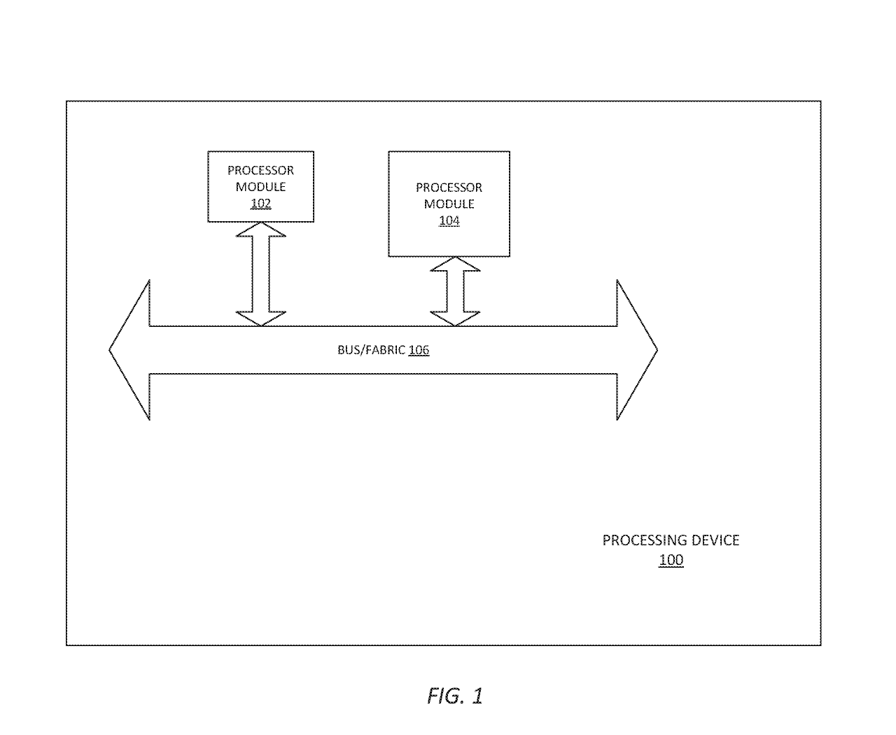

FIG. 1 illustrates a processing device 100 according to an embodiment. The processing device 100 may be a SoC positioned on a same die or a same substrate and may represent a central processing unit (CPU) fabricated on the SoC. The SoC may include integrated circuits that are efficiently fabricated in a same semiconductor fabrication process. The processing device 100 as shown in FIG. 1 may include a first processor module 102, a second processor module 104, and a bus and/or communication fabric 106 that provides the communication interface between processor modules 102 and 104, and between the processor modules 102, 104 and other components (not shown) on the SoC or outside the SoC.

In an embodiment, processor module 102 may include one or more processing cores that are designed according to a first type of ISA, and processor module 104 may include one or more processing cores that are designed according to a second type of ISA, where the second type is different from the first type. The ISA types may include different flavors of CISC or RISC architecture. For example, the ISAs may be any of IA, ARM, and PowerPC architectures. In an embodiment, processor module 102 may include processing cores designed according to IA that may be specifically suitable for supporting the Windows OS, and processor module 104 may include processing cores designed according to ARM that may be specifically suitable for supporting the Android OS. In an embodiment, a computing device that supports multi- or dual ecosystems may be built using the processing device 100. When the computing device is switched to or booted up as a Windows device, processor module 102 may actively run on the foreground to natively support execution of Windows applications while processing module 104 may run on the background or stay idle. Alternatively, when the computing device is switched to or booted up as an Android device, processor module 104 may run on the foreground to natively support executions of Android applications while processor module 102 may run on the background or stay idle. In this way, an efficient and high-performing, dual-ecosystem computing device is achieved.

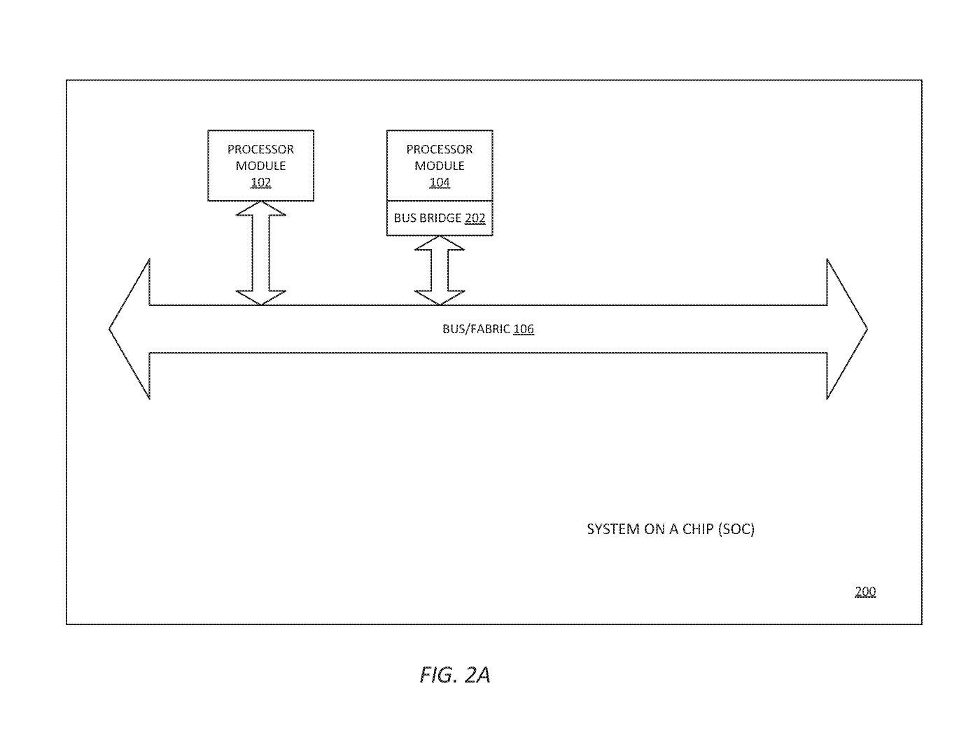

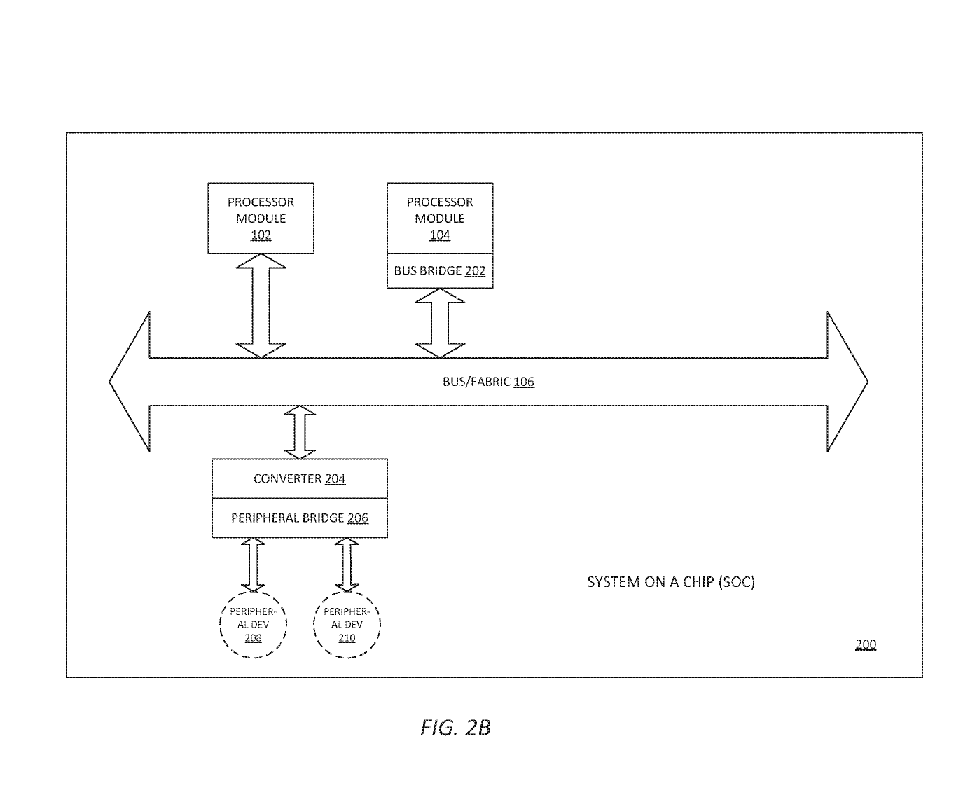

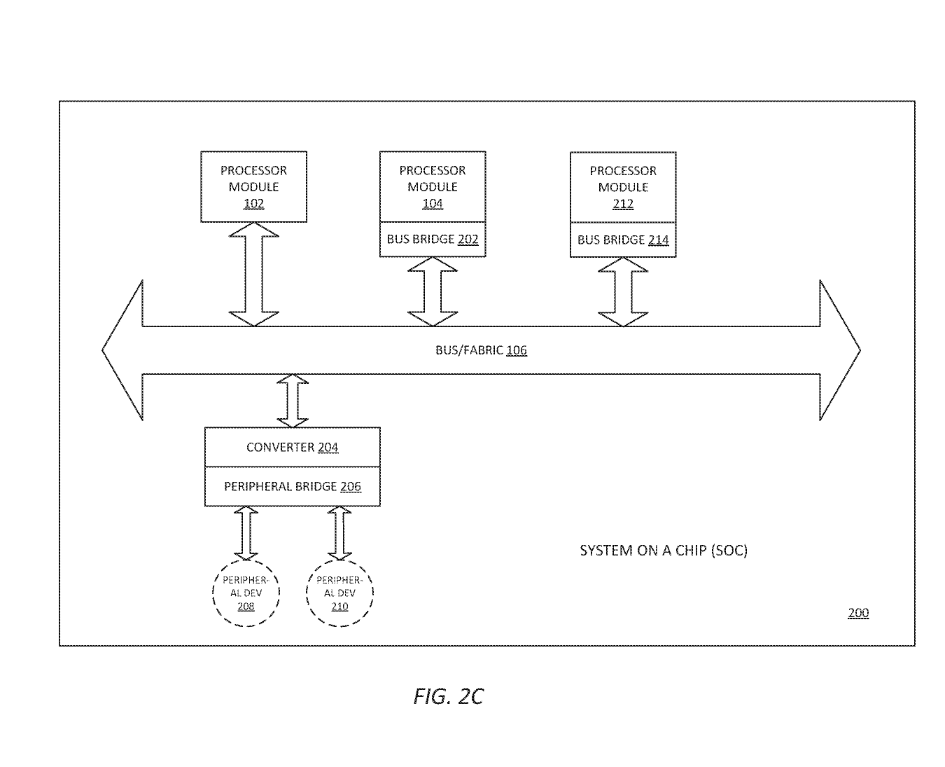

Bus 106 may be coupled to processor modules 102, 104 to provide an interface for data communication and control signaling. In practice, bus 106 may be designed according to a particular type of ISAs. Thus, to provide communication channels between processor modules 102, 104 that are designed according to different types of ISAs, further modules for translating the data and messages may be needed. FIG. 2A illustrates a processing device 200 including circuit modules for communications between different ISA cores according to an embodiment. The processing device 200 as shown in FIG. 2A may include processor modules 102, 104, and bus and/or fabric 106 similar to the processing device as shown in FIG. 1. Additionally, the processing device 200 may include a bus bridge 202 that is coupled between processor module 104 and bus 106. Bus 106 may be designed for the ISA type of processor module 102, and thus may not be capable of direct communication with processor module 104 of a different ISA type. Bus bridge 202 coupled between processor module 104 and bus 106 may translate messages from processor module 104 into a format that is suitable for bus 106 and understood by processor module 102. Conversely, bus bridge 202 may translate messages from processor module 102 via bus 106 into the format that is suitable for processor module 104.

In an embodiment, processor module 102 may include cores of IA type, and bus 106 may be specifically designed to handle messages from IA cores. For example, bus 106 may be a system agent (SA) that may handle Intel® in-die interconnect (IDI) messages. Processor module 104 may include cores whose types are different from IA. In an embodiment, the cores within processor module 104 may be an ARM type and designed to communicate messages according to the Advanced Microcontroller Bus Architecture (AMBA) protocol. Bus bridge 202 may convert IDI messages from processor module 102 to AMBA messages for processor module 104 to read, or conversely, from AMBA messages from processor module 104 to IDI messages for processor module 102 to read.

In an alternative embodiment, processor module 102 may include cores of ARM type, and bus 106 may be specifically designed to handle messages from ARM cores. For example, bus 106 may be an SA that may handle AMBA messages. Processor module 104 may include cores whose types are different from AMBA. In an embodiment, the cores within processor module 104 may be an IA type and designed to communicate messages according to IDI messages. Bus bridge 202 may convert AMBA messages from processor module 102 to IDI messages for processor 104 to read, or conversely, from IDI message from processor module 104 to AMBA messages for processor module 102 to read.

The heterogeneous cores of the processing device 200 may communicate with peripheral devices that may not be on the SoC. FIG. 2B illustrates the processing device 200 including circuit modules for communications between cores and peripheral devices according to an embodiment. Compared to FIG. 2A, processing device 200, as shown in FIG. 2B, may additionally include a converter 204 and a peripheral bridge 206 for communicating messages and control signals between the processing device 200 and peripheral devices 208, 210. Converter 204 may be part of a system agent and coupled to bus 106, and peripheral bridge 206 may be coupled between converter 204 and peripheral devices 208, 210. Peripheral devices 208, 210, which may not be part of the SoC, are collectively controlled by the heterogeneous processing modules 102, 104 so that each peripheral device may be addressed by any one of the processing modules. Converter 204 may convert different types of messages and control signals from the heterogeneous cores in processing modules 102, 104 into formats that the peripheral bridge 206 may recognize so that it may pass the messages and control signals to the appropriate peripheral device.

In an embodiment, converter 204 may handle internal commands/interrupts to and from cores including cores to peripheral devices which may be coupled to other SoC including heterogeneous cores. In this regard, converter may adapt internal commands/interrupts designed for a first type of core to a second type. For example, converter 204 may adapt Intel® On-chip System Fabric (IOSF) bus and peripheral devices that are designed for IA cores to communicate with ARM cores. In another embodiment, converter 204 may manage the direct data connections between cores and peripheral devices. For example, converter 204 may write control codes to memory-mapped I/O (MMIO) registers of peripheral devices so that peripheral devices exclusively designed for a first type of ISA may talk to (send messages and interrupts) the second type of cores, and peripheral devices designed exclusively for a second type of ISA talk to the first type of cores.

Although embodiments as shown in FIGS. 2A and 2B are discussed in terms of a processing device 200 including two types of ISA cores, aspects of the present disclosure may be easily extended to multiple types of ISA cores. FIG. 2C illustrates the processing device including processor modules of multiple ISAs according to an embodiment. Compared to FIG. 2B, processing device 200 as shown in FIG. 2C may additional include a third processor module 212 and an additional bus bridge 214. Processor module 212 may include cores designed according a third type of ISA which differs from the ISA of processor module 102 or 104. Bus bridge 214 coupled between processor module 212 and bus 106 (which is designed according to the ISA of processor module 102) may translate messages between processor module 212 and bus 106. Thus, processing device 200 may include heterogeneous cores of more than two types and designed into a computing device that can support more than two ecosystems.

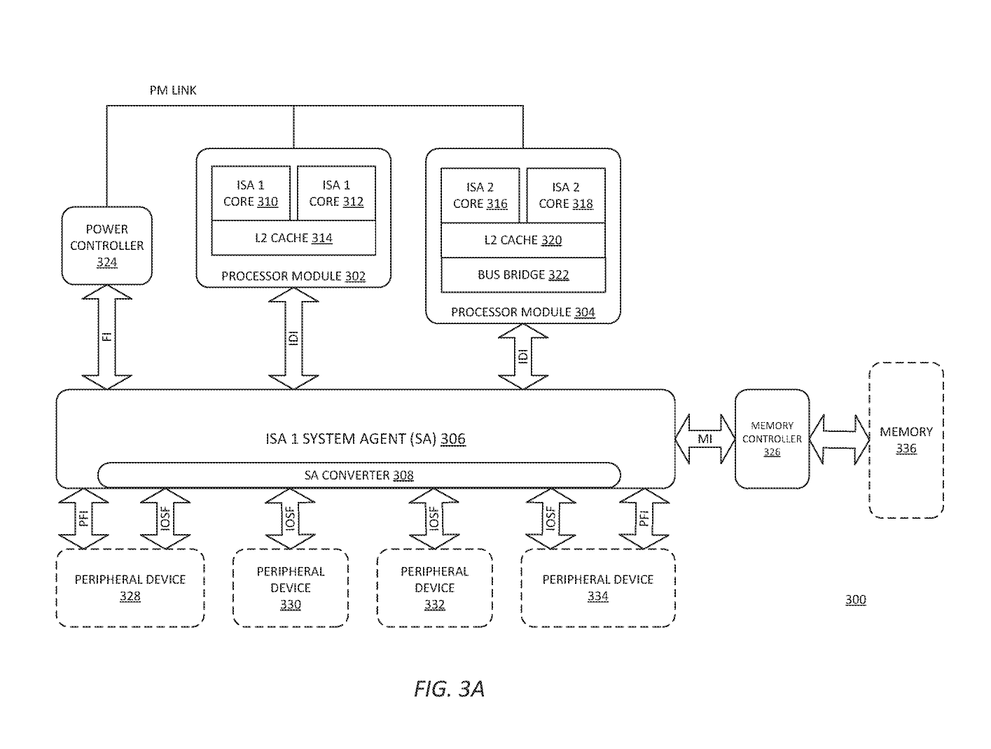

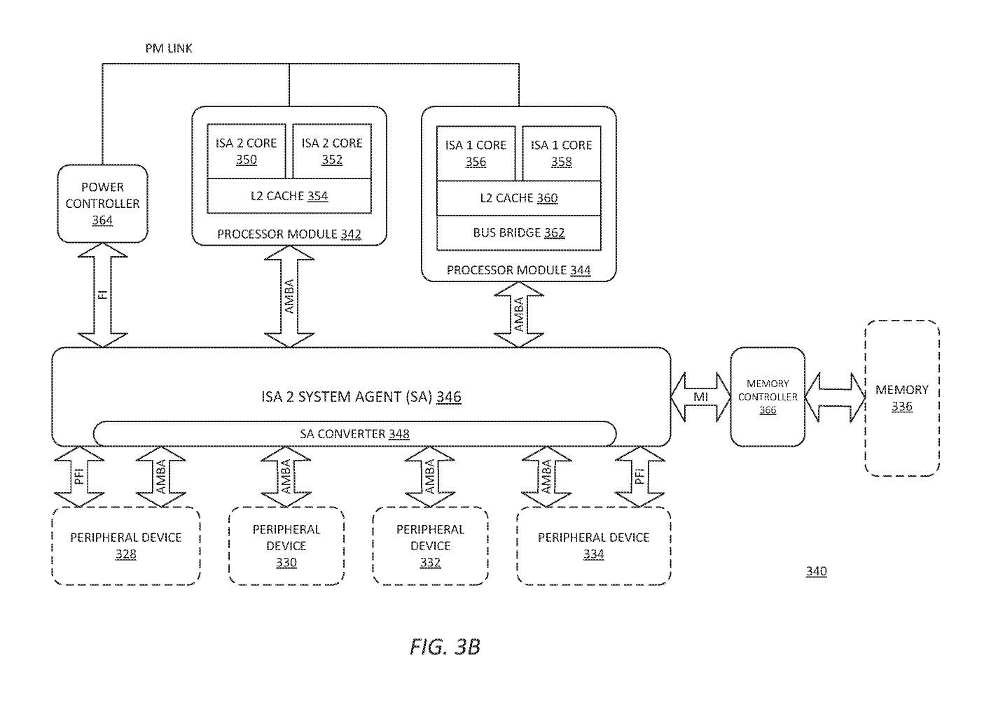

FIG. 3A illustrates a detailed schematic of a processing device 300 according to an embodiment. Processing device, as shown in FIG. 3A, may include a first processor module 302, a second processor module 304, and an IA system agent (SA) 306 which may further include bus/fabric (not shown) and an SA converter 308. Processor module 302 may further include one or more first type of ISA or ISA 1 (such as IA) cores 310, 312 and a level-2 cache 314 that may be used to stage data for IA cores 310, 312. Processor module 304 may further include one or more second type or ISA 2 (such as ARM) cores 316, 318, a level-2 cache 320, a bus bridge 322 in which level-2 cache 320 may be used to stage data for ARM cores 316, 318 and for bus bridge 322. Bus bridge 322 may convert messages transmitted between ARM cores 316, 318 and SA 306.

Processing device 300 may also include a power controller 324, coupled to processor modules 302, 304 and SA 306, for managing powers supplied to processor modules 302, 304 via power management (PM) links Processing device 300 may also include a memory controller 326 that may be coupled SA 306 using memory interface (MI) protocol. Memory controller 326 may control data read/write to a memory device 336 (such as a DDR memory).

Additionally, SA 306 may be coupled to peripheral devices 328-334 via converter 308. Peripheral devices may belong to one of three categories including exclusive IA, exclusive ARM, and non-exclusive. The exclusive-IA peripheral devices operate only when the processing device 300 actively runs processor module 302 on the foreground. The exclusive-AMR devices operate only when the processing device 300 actively runs processor module 304 on the foreground. The non-exclusive peripheral devices may operate either when processor module 302 is on the foreground or when processor module 304 is on the foreground. The communication between converter 308 and peripheral devices 328-334 may achieve via bus communicating according to Intel® On-System Fabric (IOSF) protocol or a fabric interface (FI) protocol.

In operation, IA cores 310, 312 may transmit messages to SA 306 according to the IDI protocol. Bus bridge 322 may convert the IDI message from IA cores 310, 312 to a format that may be read by ARM cores 316, 318. Conversely, bus bridge 322 may convert AMBA messages from ARM cores 316, 318 to IDI messages and transmit the IDI message to SA 306. The messages may include core-initiated memory and I/O operations and agent-initiated snoops and interrupts and power management interface.

SA 306 may control IOSF bus therein which may be coupled to other modules on the SoC. SA 306 may also handle internal commands and/or interrupts to and from the heterogeneous cores. To adapt the IOSF bus within SA 306 and other devices to the ARM cores 316, 318, SA converter 306 may convert IOSF bus protocol messages and internal commands/interrupts for the ARM cores 316, 318.

In an embodiment, processing device 300 may provide inter-core communication tunnels that directly link IA cores 310, 312 and ARM cores 316, 318 to a shared memory (SM) portion of memory 336. In this way, heterogeneous cores may access memory at a high speed.

Power controller 324 may, via the FI protocol message through SA 306, communicate with processor modules 302, 304. For example, power controller may receive a request generated by the foreground cores to switch the currently-running operating system (OS). In response to this request, power controller may issue instruction through PM link to reduce the power supply to the foreground active cores to bring them to an idle state, and simultaneously, to increase the power supply to the background cores to bring them to active. For example, if processing device 300 is actively running IA cores 310, 312 and idling ARM cores 316, 318, in response to a request to switch, power controller 324 may reduce power supply to processor module 302 and increase power supply to processor module 304 so that IA cores 310, 312 may become idle and ARM cores 316, 318 may become active.

Processing device 300 as shown in FIG. 3A is built around an IA system agent 306. Alternatively, processing devices may be built around other types of system agent. FIG. 3B illustrates a processing device 340 that is built around an ARM system agent according to an embodiment. Processing device 340 as shown in FIG. 3B may include an ARM system agent (SA) 346 that is designed according to ARM communication protocols such as AMBA. Processing device 340 may also include processor modules 342, 344, power controller 346, and memory controller 366. Processor module 342 may further include one or more the second type of ISA, or ISA 2 (such as ARM) cores 350, 352 and level-2 cache 354, and processor module 344 may further include one or more the first type of ISA or ISA 1 (such as IA) cores 356, 358, level-2 cache 360, and bus bridge 362. SA 346 may further include ARM bus (not shown) and converter 348. Since SA 346 is designed to operate collaboratively with ARM cores, processor module 342 may communicate with the ARM SA 346 according to the AMBA protocol. In contrast, processor module 344 including IA cores 356, 358 may communicate with SA 346 through bus bridge 362 which may convert IA core messages into AMBA format or vice versa so that processor modules 342 may exchange messages with processor module 344 through SA 346. Similarly, converter 348 may convert commands and/or interrupts from IA cores 356, 358 to peripheral devices 328-334 that are designated as IA devices, or vice versa. In practice, processing device 340 may operate in a manner similar to processing device 300 as shown in FIG. 3A.

A computing device that is configured with dual or multiple OSes may operate in a hardware-shared accessible mode, a software-shared accessible mode, or an exclusively-accessible mode. Under the hardware-shared accessible mode, the computing device may concurrently and actively operate more than one OS (such as both Windows and Android). To achieve the hardware-shared accessible mode, each of the processing modules (such as 302, 304 as shown in FIG. 3A, or 342, 344 as shown in FIG. 3B) may be equipped with their respective drivers. Converter 308 (or 348) embedded in SA 308 (or 348) controlling message exchange and event dispatch between cores and peripheral devices may multiplex interrupts to each of the OSes that are concurrently running.

Under software-shared accessible mode, the computing device may concurrently and actively operate more than one OS by virtualization. Virtual drivers may be constructed to forward messages between OSes among heterogeneous cores. Although both hardware-shared accessible and software-shared accessible modes simultaneously run more than one OS, with respect to peripheral devices, one of the OS may be the master, and the rest OSes may be the slaves. The master OS may primarily manage peripheral devices, exclusively access peripheral devices, or share the peripheral devices with slave OSes.

Under the exclusively-accessible mode, the computing device may run only one OS on the foreground and place the rest of the OSes in the background or in idle states. Foreground OS may run on the processor module including cores native to the foreground OS. For example, Windows and its applications when they are on the foreground may run on IA cores, and Android and its applications when they are on the foreground may run on ARM cores. In response to a request to switch, the foreground and background OSes may be switched.

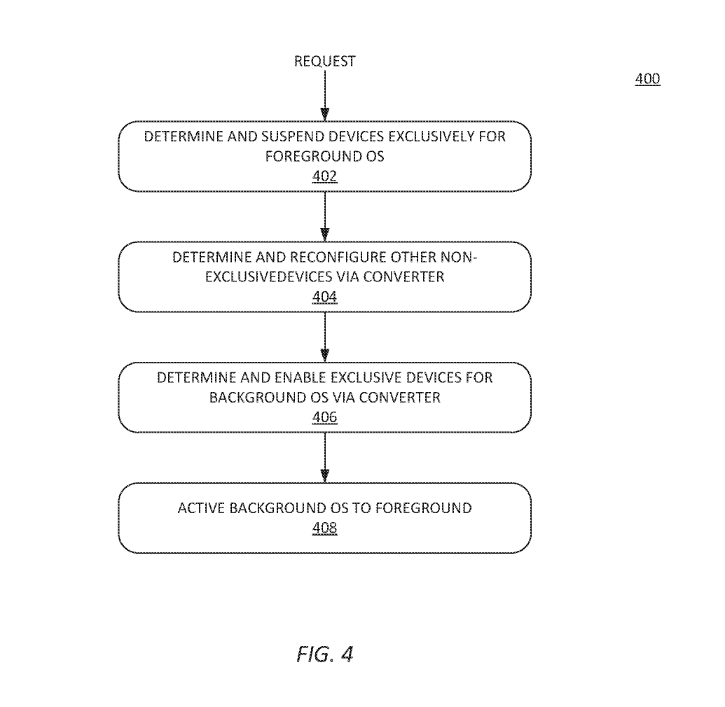

FIG. 4 is a block diagram of a method for switching OSes in a dual-OS computing device according to an embodiment. Method 400 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by processing logics of any one of the processor modules 102, 104, 212, 302, 304, 342, 344 described above with respect to FIGS. 1, 2A-2C, 3A-3B.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4, a processing logic may receive a request to switch OSes. The request may be generated in response to an instruction issued by a user of the computing device, or in response to an event triggered by a logic within the computing device, or in response to a schedule (such as at certain time of each day or month). In response to the request, at 402, the processing logic executing the currently running OS may determine a first set of devices that are exclusively designed to operate under the currently running OS and issue instructions to suspend the first set of devices. In an embodiment, the determination may be achieved by matching identifications of the set of devices with a table that specifies categories of the devices. At 404, the processing logic executing the currently running OS may further determine, by inquiring the table, a second set of devices that are not exclusive to either the currently-running foreground OS or the background OS, and reconfigure, via converter in the system agent, the second set of devices so that the second set of devices are in a state that is suitable to run under the background OS. The reconfiguration may include rewriting MMIO registers of these devices. At 406, the processing logic executing the currently running foreground OS may determine, by inquiring the table, a third set of devices that are currently idle because they are exclusively to operate under the background OS, and enable/resume, via the converter, the third set of devices. At 408, the processor executing the currently running OS may activate the background OS to the foreground and simultaneously deactivate previously running foreground OS. The switch of OSes may also cause a switch among heterogeneous cores in different processor modules as shown in embodiments of the present disclosure.

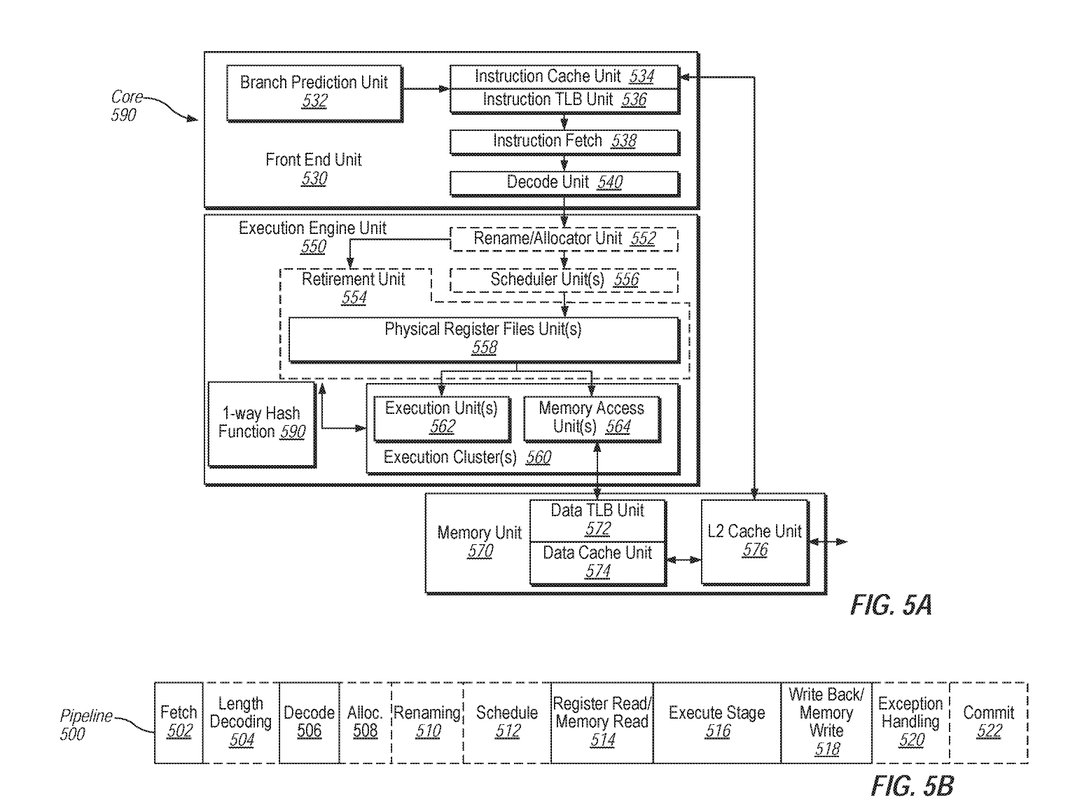

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processors 100, 200, 300, and 340 described with respect to FIGS. 1, 2A-2C, 3A, and 3B.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processing device 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

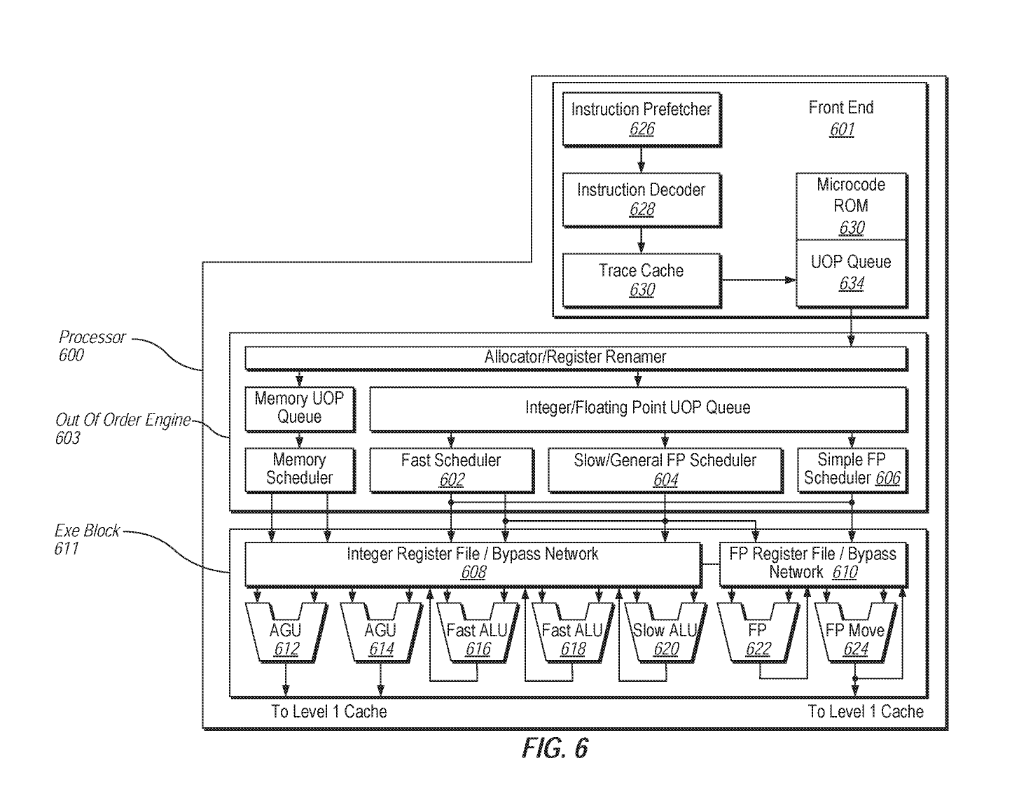

FIG. 6 illustrates a block diagram of the micro-architecture for a processor 600 that includes hybrid cores in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMXTM registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

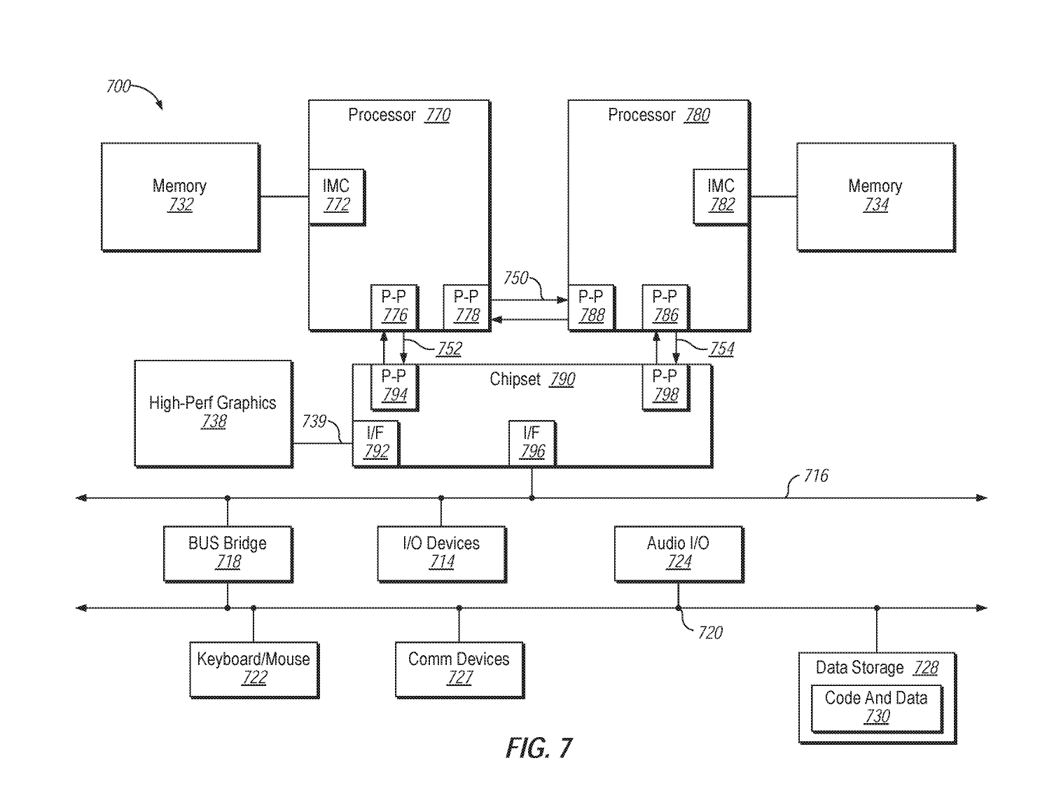

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement hybrid cores as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

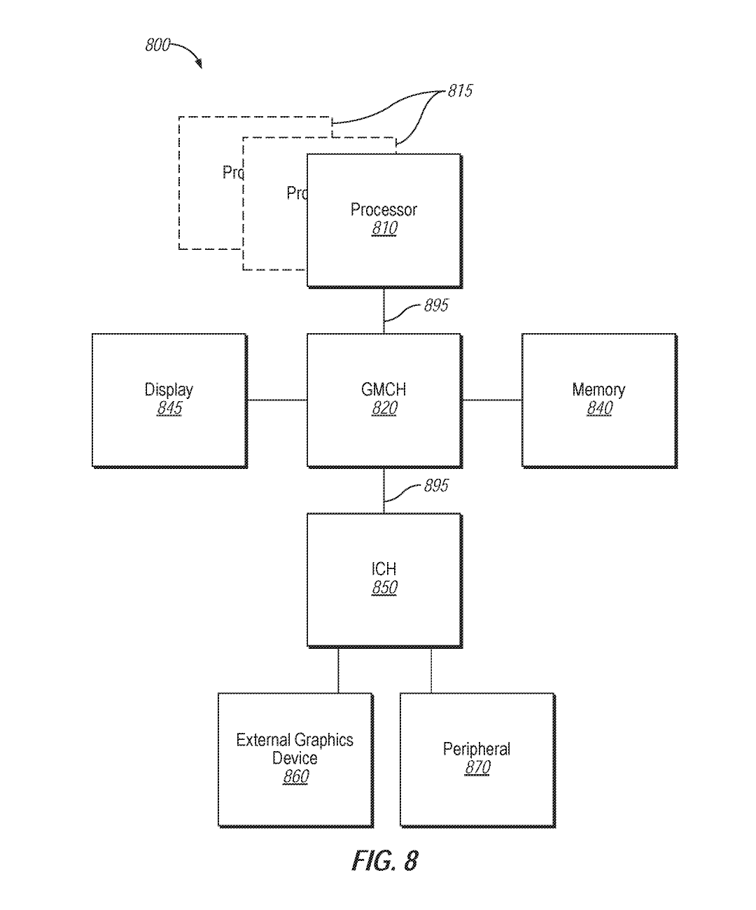

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement hybrid cores according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

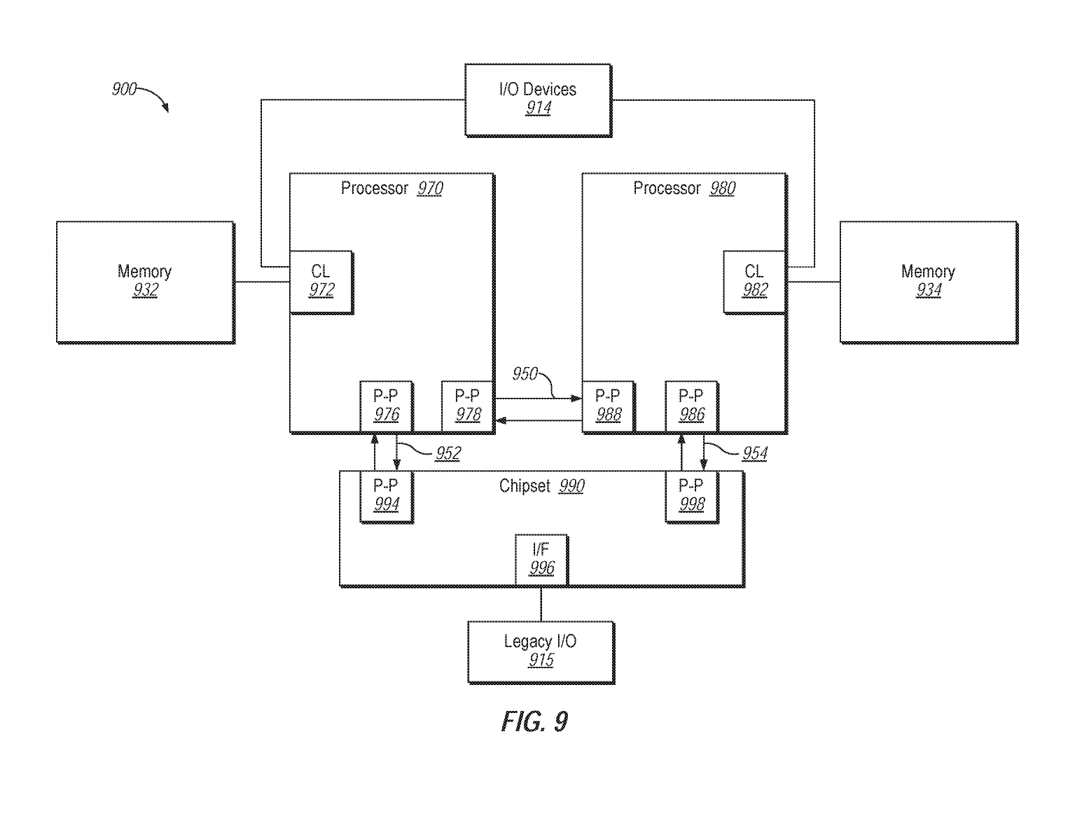

Referring now to FIG. 9, shown is a block diagram of a system 900 in which an embodiment of the disclosure may operate. FIG. 9 illustrates processors 970, 980. In one embodiment, processors 970, 980 may implement hybrid cores as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

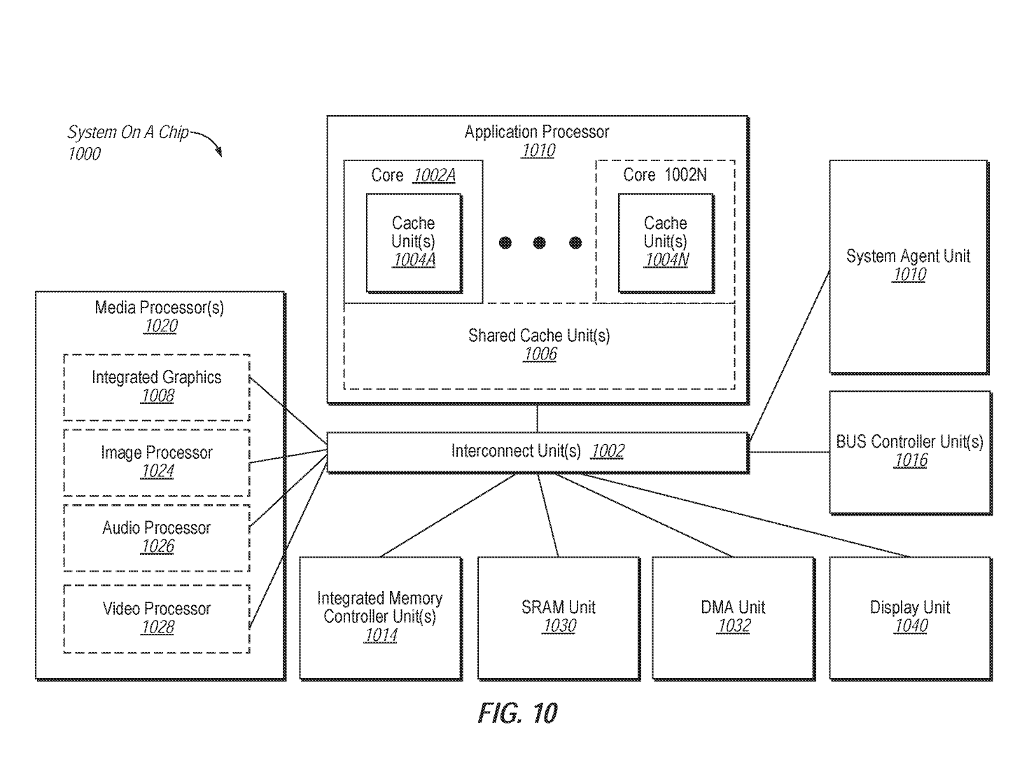

Embodiments may be implemented in many different system types. FIG. 10 is a block diagram of a SoC 1000 in accordance with an embodiment of the present disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a store address predictor for implementing hybrid cores as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

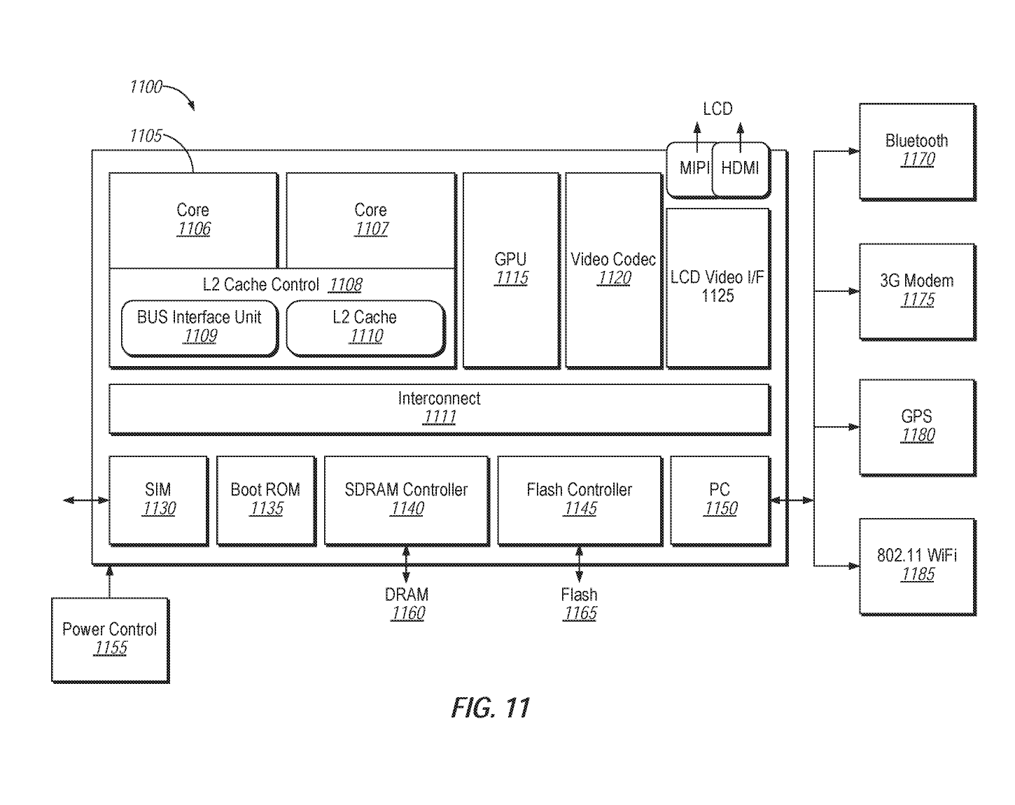

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores-1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement hybrid cores as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

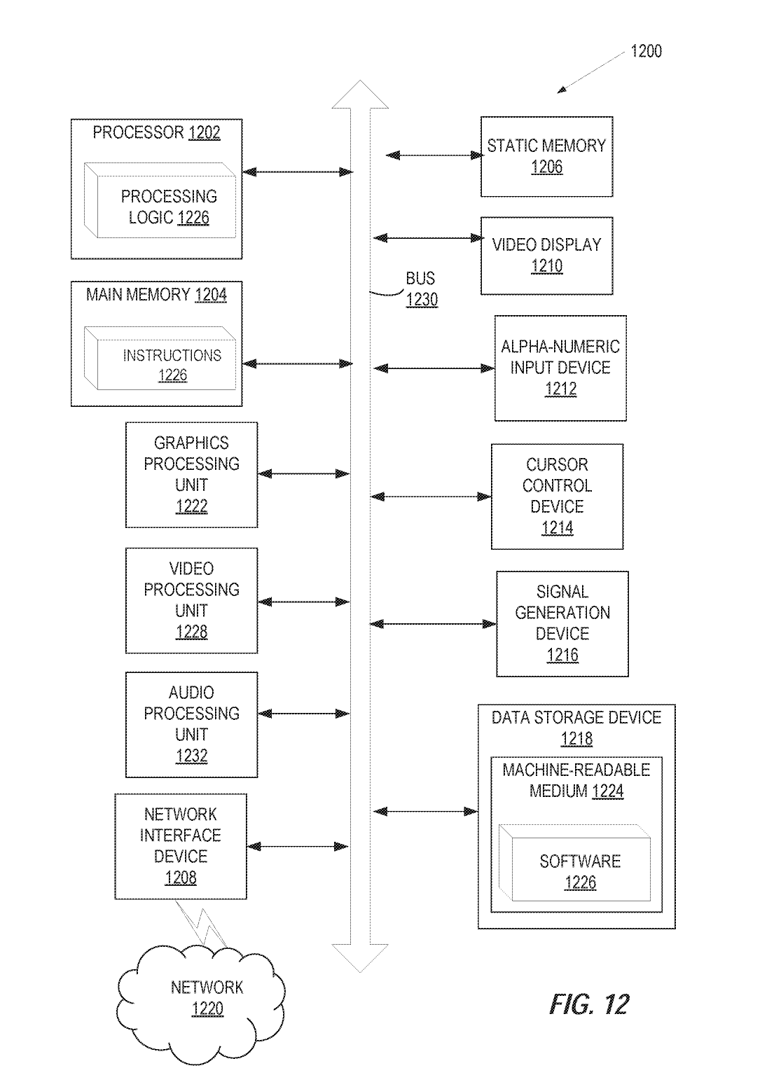

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein. In one embodiment, processing device 1202 is the same as processor architecture 100 described with respect to FIG. 1 that implements hybrid cores as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction for hybrid cores such as described according to embodiments of the disclosure. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processing device that can include a first processor module comprising a first core designed according to a first instruction set architect (ISA), and a second processor module comprising a second core designed according to a second ISA, in which the second processor module is fabricated on a same die as the first processor module.

In Example 2, the subject matter of Example 1 can optionally include a system agent (SA) comprising a bus that is communicatively coupled to the first and second processor modules.

In Example 3, the subject matter of Example 2 can optionally provide that the bus is designed to natively transmit messages to and from the first core.

In Example 4, the subject matter of any one of Examples 2 and 3 can optionally provide that the second processor module comprises a bus bridge for converting messages transmitted between the second core and the bus.

In Example 5, the subject matter of any one of Examples 2 and 3 can optionally provide that the SA further comprises a converter through which the SA is coupled to a plurality of peripheral devices.

In Example 6, the subject matter of any one of Examples 1-3 can optionally provide that the processing device is a system-on-a-chip (SoC) device fabricated on the same die.

In Example 7, the subject matter of any one of Examples 1-3 can optionally provide that the processing device is part of a computing device which is ported with more than one operating system.

In Example 8, the subject matter of any one of Examples 1-3 can optionally provide that wherein a first operating system, when activated, runs on the first processor module, and a second operating system, when activated, runs on the second processor module.

In Example 9, the subject matter of Example 8 can optionally provide that the processing device is a central computing unit (CPU) and part of a computing device which is ported with dual operating systems.

In Example 10, the subject matter of any one of Examples 1-3 can optionally further include a third processor module comprising a third core designed according to a third instruction set (ISA) which is different from the first and the second ISAs.

In Example 11, the subject matter of any one of Examples 1-3 can optionally provide that the third processor module comprises a third bus bridge for converting messages transmitted among the first, second, and third cores.

Example 12 is a processor that can include a first core designed according to a first instruction set architecture (ISA), and a second core designed according to a second ISA, in which the processor is a system-on-a-chip (SoC) device fabricated on a single die.

In Example 13, the subject matter of Example 13 can optionally further include a system agent (SA) comprising a bus that is communicatively coupled to the first and second cores, in which the bus is designed to natively transmit messages to and from the first core.

In Example 14, the subject matter of any one of Examples 12 and 13 can optionally further include a bus bridge coupled between the second core and the bus, in which the bus bridge converts messages transmitted between the second core and the bus.

In Example 15, the subject matter of any one of Examples 12-14 can optionally provide that the SA further comprises a converter through which the SA is coupled to a plurality of peripheral devices.

In Example 16, the subject matter of any one of Examples 12-14 can optionally provide that a first operating system, when activated, runs on the first processor module, and a second operating system, when activated, runs on the second processor module.

In Example 17, the subject matter of Example 17 can optionally provide that the processing device is a central computing unit (CPU) and part of a computing device which is ported with dual operating systems.

In Example 18, the subject matter of any one of Examples 12-14 can further include a third core designed according to a third instruction set (ISA) which is different from the first and the second ISAs.

In Example 19, the subject matter of any one of Examples 12-14 can optionally provide that the third core comprises a third bus bridge for converting messages transmitted among the first, second, and third cores.

Example 20 is a method which may include in response to a request to switch from a first operating system (OS) executing in foreground on a central processing unit (CPU) to a second OS executing in background on the CPU, determining, by a first core of the CPU, a first set of devices that are associated exclusively with the first OS, the first core designed according to a first type of instruction set architecture (ISA), a first set of devices that are exclusively for the first OS, suspending the first set of devices, determining a second set of devices that are not exclusive to the first and second OSes, reconfiguring the second set of devices for the second OS, and switching the second OS to the foreground and the first OS to the background, wherein the switching comprises activating a second core of the CPU designed according to a second type of ISA, and idling the first core.

In Example 21, the subject matter of Example 21 can optionally include determining a third set of devices that are exclusive to the second OS, and enabling the third set of devices.

Example 22 is a non-transitory computer-readable medium including a plurality of instructions that in response to being executed on a central computing unit (CPU), cause the CPU to carry out a method, the method including in response to a request to switch from a first operating system (OS) executing in foreground on a central processing unit (CPU) to a second OS executing in background on the CPU, determining, by a first core of the CPU, a first set of devices that are associated exclusively with the first OS, the first core designed according to a first type of instruction set architecture (ISA), a first set of devices that are exclusively for the first OS, suspending the first set of devices, determining a second set of devices that are not exclusive to the first and second OSes, reconfiguring the second set of devices for the second OS, and switching the second OS to the foreground and the first OS to the background, wherein the switching comprises activating a second core of the CPU designed according to a second type of ISA, and idling the first core.

In Example 23, the subject matter of Example 22 can optionally further include determining a third set of devices that are exclusive to the second OS, and enabling the third set of devices.

Example 24 is an apparatus that can include in response to a request to switch from a first operating system (OS) executing in foreground on a central processing unit (CPU) to a second OS executing in background on the CPU, means for determining a first set of devices that are associated exclusively with the first OS, the first core designed according to a first type of instruction set architecture (ISA), means for suspending the first set of devices, means for determining a second set of devices that are not exclusive to the first and second OSes, means for configuring the second set of devices for the second OS, and means for switching the second OS to the foreground and the first OS to the background, wherein the switching comprises activating a second core of the CPU designed according to a second type of ISA, and idling the first core.

In Example 25, the subject matter of Example 24 can optionally further include means for determining a third set of devices that are exclusive to the second OS, and means for enabling the third set of devices.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,' and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1-24. (Canceled)

25. A processing device, comprising:
a first processor circuit comprising a first core designed according to a first instruction architecture set (ISA); and
a second processor circuit comprising a second core designed according to a second ISA, wherein the second processor circuit is fabricated on a common die as the first processor circuit.

26. The processing device of claim 25, further comprising:
a system agent (SA) comprising a bus that is communicatively coupled to the first processor circuit and the second processor circuit.

27. The processing device of claim 26, wherein the bus is to natively transmit messages to and from the first core.

28. The processing device of claim 27, wherein the second processor circuit comprises a bus bridge to convert the messages transmitted between the second core and the bus.

29. The processing device of claim 26, wherein the SA further comprises a converter through which the SA is coupled to a plurality of peripheral devices.

30. The processing device of claim 25, wherein the processing device is a system-on-a-chip (Soc) device fabricated on the common die.

31. The processing device of claim 25, wherein the processing device is part of a computing device which is ported with a plurality of operating systems.

32. The processing device of claim 25, wherein the processing device is a central computing unit (CPU) and part of a computing device which is ported with dual operating systems, and wherein a first operating system, when activated, runs on the first processor circuit, and a second operating system, when activated, runs on the second processor circuit.

33. The processing device of claim 32, wherein the first operating system comprises a Windows operating system and the second operating system comprises an Android operating system.

34. The processing device of claim 25, further comprising:
a third processor circuit comprising a third core designed according to a third ISA which is different from the first ISA and the second ISA.

35. The processing device of claim 25, wherein the first ISA comprises an Intel Architecture (IA) and the second ISA comprises an ARM architecture.

36. A processor, comprising:
a first core designed according to a first instruction set architecture (ISA); and
a second core designed according to a second ISA, wherein the processor is a system-on-a-chip (Soc) device fabricated on a single die.

37. The processor of claim 36, further comprising:
a system agent (SA) comprising a bus that is communicatively coupled to the first and second cores, wherein the bus is to natively transmit messages to and from the first core.

38. The processor of claim 37, further comprising:
a bus bridge coupled between the second core and the bus, wherein the bus bridge converts messages transmitted between the second core and the bus.

39. The processor of claim 37, wherein the SA further comprises a converter through which the SA is coupled to a plurality of peripheral devices.

40. The processor of claim 36, wherein the processor is a CPU and is part of a computing device which is ported with dual operating systems, and wherein a first operating system is to run on the first core, and a second operating system is to run on the second core.

41. The processor of claim 40, wherein the operating systems the first operating system comprises a Windows operating system and the second operating system comprises an Android operating system.

42. The processor of claim 36, wherein the first ISA comprises an Intel Architecture (IA) and the second ISA comprises an ARM architecture.

43. The processor of claim 36, further comprising a third core natively designed according to a third ISA that is different from the first ISA and the second ISA.

44. A method comprising:
in response to receiving a request to switch from a first operating system (OS) in foreground to a second OS in background, determining, by a first core designed according to a first instruction set architecture (ISA), a first set of peripheral devices that are exclusively associated with the first OS;
suspending operations of the first set of peripheral devices;
determining a second set of peripheral devices that are associated with the first OS and the second OS;
programming the second set of peripheral devices to run under the second OS;
switching the second OS to the foreground and the first OS to the background by activating a second core designed according to a second type of ISA and idling the first core, wherein the first core and the second are part of a central processing unit (CPU).

45. The method of claim 44, further comprising:
determining a third set of peripheral devices that are exclusive to the second OS;
enabling the third set of peripheral devices.
